(19) United States
(12) Patent Application Publication
(10) Pub. No.: US 2014/0344473 A1
(43) Pub. Date: Nov. 20, 2014

(54) TRANSMISSION MANAGEMENT DEVICE, SYSTEM, AND METHOD

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/278,640

(22) Filed: May 15, 2014

(30) Foreign Application Priority Data
May 16, 2013 (CN) 2013101815236

(51) Int. Cl. H04L 12/721

(52) U.S. Cl. CPC H04L 45/12
USPC 709/238

(57) ABSTRACT

A transmission management method, includes: receiving a request for establishing an on-demand virtual lease line from a first electronic device when a request is made to communicate with a second electronic device. geographic positions of the first electronic device, the second electronic device, and routers are determined. A data transmission direction is determined according to the geographic positions of the first and the second electronic device. Routers located between the first electronic device and the second electronic device are determined gradually. Positions and workloads of the routers located between the first and second electronic device are analyzed, and an optimal transmission path is determined according to the positions and workloads of the router. The first electronic device and the second electronic device are controlled to communicate with each other via the determined optimal transmission path.

### CROSS REFERENCE TO RELATED APPLICATIONS

This application is related to the following co-pending, commonly assigned patent applications, the disclosures of which are incorporated herein by reference in their entirety:

1. “TRANSMISSION MANAGEMENT DEVICE, SYSTEM, AND METHOD” by Steve Lap Wai Hui, whose Attorney Docket No is US51796.

2. “TRANSMISSION MANAGEMENT DEVICE, SYSTEM, AND METHOD” by Steve Lap Wai Hui, whose Attorney Docket No is US51797.

3. “TRANSMISSION MANAGEMENT DEVICE, SYSTEM, AND METHOD” by Steve Lap Wai Hui, whose Attorney Docket No is US51798.

### FIELD

The present disclosure relates to devices, and particularly to a transmission management device, a system, and a method thereof.

### BACKGROUND

Electronic devices, such as mobile phones and tablet computers, are popular. Usually, the electronic devices can communicate with each other and access network via corresponding networks, such as internet, a code division multiple access (CDMA) network, or a broadcasting network. However, in some situations, when electronic devices connect to networks according to a certain network bandwidth assigned by a corresponding network operator, and when the number of people accessing the network is great, the resulting access speed can be very slow.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a transmission management device.

FIG. 2 is a schematic diagram of a first embodiment of a transmission path established randomly.

FIG. 3 is a schematic diagram of a first embodiment of a transmission path determined by the transmission management device.

FIG. 4 is a flowchart diagram of an embodiment of a transmission management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

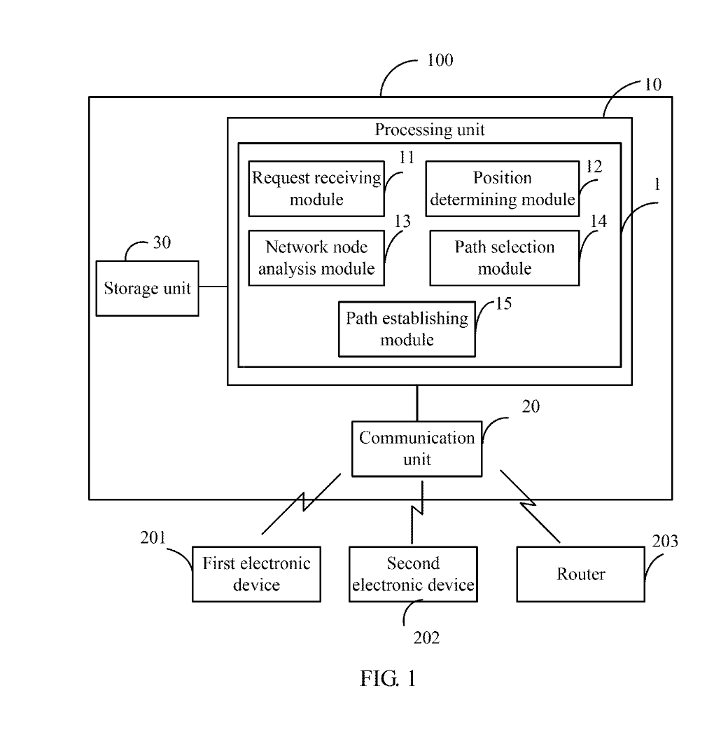

Referring to FIGS. 1-3 together, a transmission management device 100 can include a processing unit 10, a communication unit 20, and a storage unit 30.

The transmission management device 100 connects to at least one first electronic device 201, at least one second electronic device 202, and a number of routers 203 via the communication unit 20. The routers 203 respectively belong to different network operators or all belong to the same network operator. For example, the communication unit 20 connects the transmission management device 100 with the first electronic device 201, the second electronic device 202, and the routers 203 via corresponding networks, such as, internet, a wireless network including WIFI and BLUETOOTH, a telecommunication network including a general packet radio service (GPRS) network and a code division multiple access (CDMA) network, or a broadcasting network.

The storage unit 30 stores position information of each router 203, where the position information of each router 203 includes a geographic position and an internet protocol (IP) address of the router 203.

In the embodiment, the storage unit 30 further stores a transmission management system 1. The transmission management system 100 includes a number of modules, which are a collection of software instructions executed by the processing unit 10 of the transmission management device 100. The modules include a request receiving module 11, a position determining module 12, a network node analysis module 13, a path selection module 14, and a path establishing module 15. For example, in the embodiment, the storage unit 30 can be a hard disk, a compact disk, a flash memory. The processing unit 10 can be a central processing unit, a digital processor, a single chip, for example.

In the embodiment, the first electronic device 201 is an initiator of communication with the second electronic device 202 and sends data to the second electronic device 202 first.

The request receiving module 11 is used to receive a request for establishing an on-demand virtual lease line (ODVLL) from the first electronic device 201. In the embodiment, the request for establishing the ODVLL can be produced when the first electronic device 201 requests to communicate with the second electronic device 202 and sends data to the second electronic device 202.

The position determining module 11 is used to determine geographic positions of the first electronic device 201 and the second electronic device 202 and obtain geographic positions of the routers 203 stored in the storage unit 30. In the embodiment, the request for establishing the ODVLL includes position information of both of the first electronic device 201 and the second electronic device 202. The position information of the first electronic device 201 includes a geographic position and an IP address of the first electronic device 201, and the position information of the second electronic device 202 includes a geographic position and an IP addresses of the second electronic device 202. The position determining module 11 determines the geographic positions of the first electronic device 201 and the second electronic device 202 according to the position information included in the request for establishing the ODVLL.

In another embodiment, the position information of the first electronic device 201 only includes the IP address of the first electronic device 201, and the position information of second electronic device 202 only include the IP address of the second electronic device 202. The position determining module 11 locates the geographic positions of the first electronic device 201 and the second electronic device 202 according to the IP addresses of the first electronic device 201 and the second electronic device 202, based on the global position system.

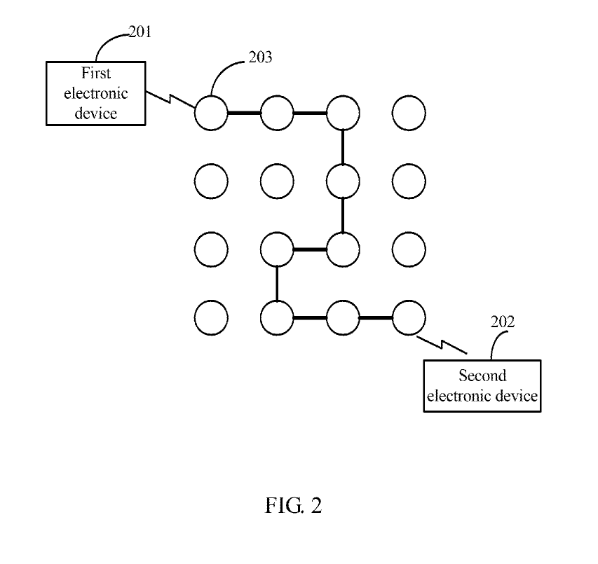

The network node analysis module 13 determines a data transmission direction from the first electronic device 201 to the second electronic device 202 according to the geographic positions of the first electronic device 201 and the second electronic device 202. In addition, the network node analysis module 13 determines a first group of routers 203 adjacent to the first electronic device 201 and located on the data transmission direction from the first electronic device 201 to the second electronic device 202. The network node analysis module 13 then determines a second group of routers 203 consisted of routers 203 adjacent to the first group of routers 203 and located on the data transmission direction, until the network node analysis module 13 determines all routers 203 located between the first electronic device 201 and the second electronic device 202 as shown in FIG. 2.

As shown in FIG. 2, these routers 203 located between the first electronic device 201 and the second electronic device 202 constitutes a number of network nodes between the first electronic device 201 and the second electronic device 202. In the embodiment, the routers 203 located between the first electronic device 201 and the second electronic device 202 are the routers 203 with geographic positions between the geographic positions of the first electronic device 201 and the second electronic device 202.

The path selection module 14 is used to analyze positions and workloads of the routers 203 located between the first electronic device 201 and the second electronic device 202, and determine an optimal transmission path according to the positions and workloads of the routers 203 located between the first electronic device 201 and the second electronic device 202. In detail, the path selection module 14 determines the routers 203 with workloads less than a predetermined value, and selects minimum routers 203 with workloads less than the predetermined value to form the optimal transmission path between the first electronic device 201 and the second electronic device 202. In detail, after the path selection module 14 determines all of the routers 203 with a workload less than the predetermined value, a number of transmission paths are determined, each consisted by several determined routers 203 adjacent to each other one by one, and then a transmission path including the minimum routers 203 is determined as the optimal transmission path also by the path selection module 14.

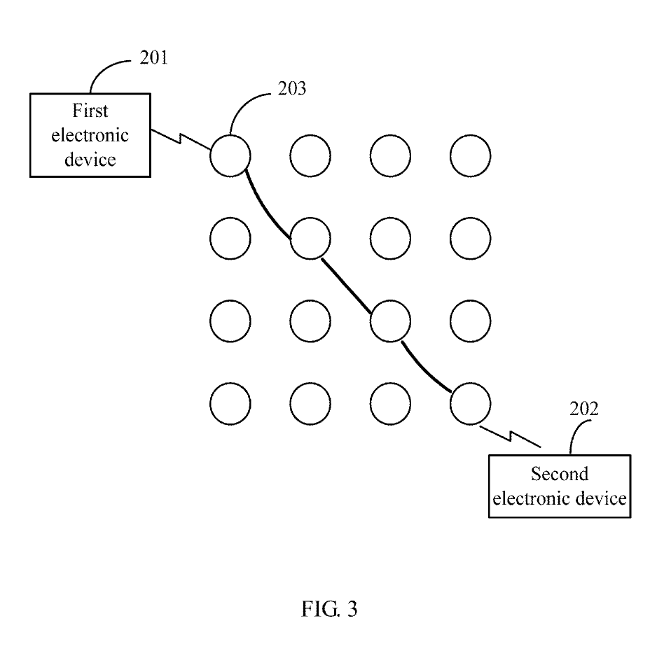

For example, as shown in FIG. 3, if the workloads of the routers 203 located between the first electronic device 201 and the second electronic device 202 are all less than the predetermined value, the path selection module 14 determines the diagonal line of the graphic consisted of all of the routers as 203 as the shortest transmission path. In addition, selects the routers 203 located on the diagonal line to form the optimal transmission path between the first electronic device 201 and the second electronic device 202.

In the embodiment, the workload of the router 203 includes network utilization ratio, or a processing load of the router 203, for example. The network utilization ratio is the ratio of current network traffic to the maximum network traffic that the router 203 can handle. When more data is transmitted/received and processed by one router 203, the network utilization ratio is great, and the workload of the router 203 is heavy. In the embodiment, the path selection module 14 determines the workload of the router 203 is less than the predetermined value by determining the network utilization ratio is less than the predetermined value. In the embodiment, the predetermined value is 50%.

The path establishing module 15 controls the first electronic device 201 and the second electronic device 202 to communicate with each other via the optimal transmission path according to the optimal transmission path determined by the path selection module 14. Thus, the first electronic device 201 and the second electronic device 202 are assigned to the ODVLL accordingly.

Thus, because the routers 203 constitute the optimal transmission path with workloads less than the predetermined value and the least number of the routers 203, then the transmission speed between the first electronic device 201 and the second electronic device 202 is enhanced.

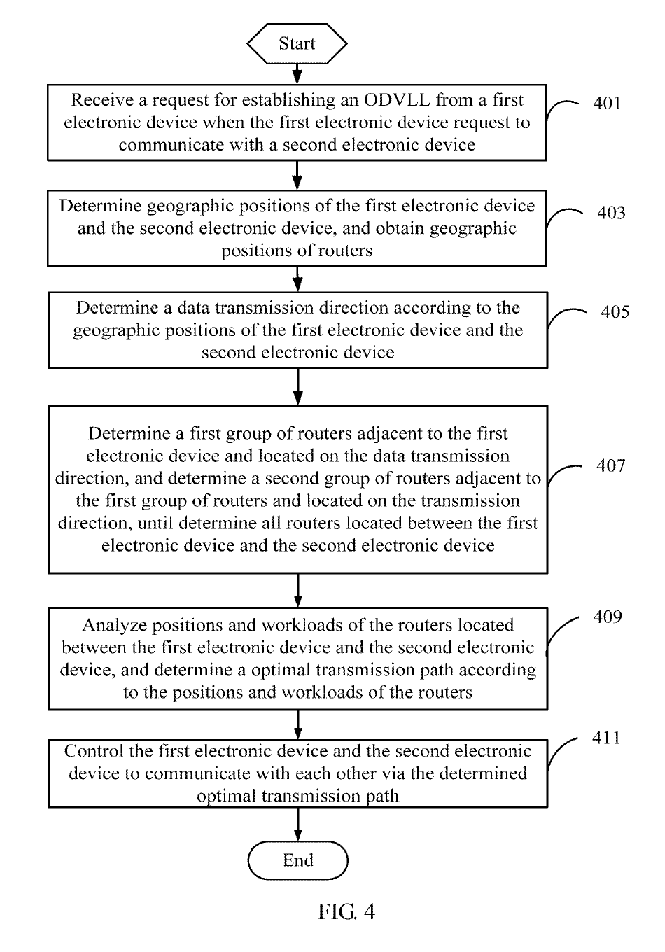

FIG. 4 shows a flowchart of a transmission management method. In 401, the request receiving module receives a request for establishing an ODVLL from the first electronic device. In one embodiment, the request for establishing the ODVLL is produced when the first electronic device requests to communicate with the second electronic device and sends data to the second electronic device, by operating a particular button or a particular item in responses to manual operation.

In 403, the position determining module determines geographic positions of the first electronic device and the second electronic device, and obtains geographic positions of the routers stored in the storage unit. In the embodiment, the request for establishing the ODVLL includes position information of both of the first electronic device and the second electronic device. The position information of the first electronic device includes a geographic position and an IP address of the first electronic device, and the position information of the second electronic device includes a geographic position and an IP address of the second electronic device. The position determining module determines the geographic positions of the first electronic device and the second electronic device according to the position information included in the request for establishing the ODVLL. In another embodiment, the position information of the first electronic device only includes the IP address of the first electronic device, and the position information of the second electronic device only includes an IP address of the second electronic device. The position determining module positions the geographic positions of the first electronic device and the second electronic device according to the IP addresses of the first electronic device and the second electronic device.

In 405, the network node analysis module determines a data transmission direction according to the geographic positions of the first electronic device and the second electronic device.

In 407, the network node analysis module determines a first group of routers adjacent to the first electronic device located on the data transmission direction relative to the first electronic device. In addition, determines a second group of routers adjacent to the first group of routers located on the data transmission direction relative to the first group of routers, until all routers located between the first electronic device and the second electronic device are determined.

In 409, the path selection module analyzes positions and workloads of the routers located between the first electronic device and the second electronic device, and determines a optimal transmission path according to the positions and workloads of the routers located between the first electronic device and the second electronic device. In the embodiment, the path selection module determines the routers with workloads less than a predetermined value, and selects adjacent routers with workloads less than the predetermined value to form the optimal transmission path between the first electronic device and the second electronic device.

In 411, the path establishing module controls the first electronic device and the second electronic device to communicate with each other via the optimal transmission path determined by the path selection module.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a storage unit and a communication unit for connecting to a plurality of routers, the transmission management system comprising:
a processing unit;
a plurality of modules which are collections of instructions executed by the processing unit, the plurality of modules comprising:
a request receiving module configured to receive a request for establishing an on-demand virtual lease line (ODVLL) from a first electronic device when the first electronic device requests to communicate with a second electronic device and sends data to the second electronic device;
a position determining module configured to determine geographic positions of the first electronic device and the second electronic device, and obtain geographic positions of the plurality of routers stored in the storage unit;
a network node analysis module configured to determine a data transmission direction according to the geographic positions of the first electronic device and the second electronic device, and determine a first group of routers adjacent to the first electronic device and located on a data transmission direction relative to the first electronic device, and then determine a second group of routers adjacent to the first group of routers and located on a data transmission direction relative to the first group of routers, until determine all routers located between the first electronic device and the second electronic device;
a path selection module configured to analyze positions and workloads of the routers located between the first electronic device and the second electronic device, and determine a optimal transmission path according to the positions and workloads of the routers located between the first electronic device and the second electronic device; and
a path establishing module configured to control the first electronic device and the second electronic device to communicate with each other via the optimal transmission path determined by the path selection module.

2. The system according to claim 1, wherein the request for establishing the ODVLL includes position information of both of the first electronic device and the second electronic device, and the position information of the first electronic device comprises a geographic position and a internet protocol (IP) address of the first electronic device, and the position information of the second electronic device comprises a geographic position and a IP address of the second electronic device, the position determining module determines the geographic positions of the first electronic device and the second electronic device according to the position information comprised in the request for establishing the ODVLL.

3. The system according to claim 2, wherein the routers located between the first electronic device and the second electronic device are those routers with geographic positions between the geographic positions of the first electronic device and the second electronic device.

4. The system according to claim 1, wherein the path selection module determines the routers with workloads less than a predetermined value, and selects least adjacent routers with workloads less than the predetermined value to form the optimal transmission path between the first electronic device and the second electronic device.

5. The system according to claim 4, wherein the workload of each router comprises a network utilization ratio of the router, and the path selection module determines the workload of the router is less than the predetermined value by determining the network utilization ratio is less than the predetermined value.

6. A transmission management device, comprising:
a communication unit configured to communicate with at least one first electronic device, at least one second electronic device, and a plurality of routers;
a storage unit configured to store position information of the plurality of routers;
a processing unit configured to execute a plurality of modules which are collection of instructions, the modules comprising:
a request receiving module configured to receive a request for establishing an on-demand virtual lease line (ODVLL) from a first electronic device when the first electronic device requests to communicate with the second electronic device and sends data to the second electronic device;
a position determining module configured to determine geographic positions of the first electronic device and the second electronic device, and obtain geographic positions of the plurality of routers stored in the storage unit;
a network node analysis module configured to determine a data transmission direction according to the geographic positions of the first electronic device and the second electronic device, and determine a first group of routers adjacent to the first electronic device and located on the data transmission direction relative to the first electronic device, and then determine a second group of routers adjacent to the first group of routers and located on the data transmission direction relative to the first group of routers, until determine all routers located between the first electronic device and the second electronic device;
a path selection module configured to analyze positions and workloads of the routers located between the first electronic device and the second electronic device, and determine a optimal transmission path according to the positions and workloads of the routers located between the first electronic device and the second electronic device; and
a path establishing module configured to control the first electronic device and the second electronic device to communicate with each other via the optimal transmission path determined by the path selection module.

7. The device according to claim 6, wherein the request for establishing the ODVLL includes position information of both of the first electronic device and the second electronic device, and the position information of the first electronic device comprises a geographic position and a internet protocol (IP) address of the first electronic device, and the position information of the second electronic device comprises a geographic position and a IP address of the second electronic device, the position determining module determines the geographic positions of the first electronic device and the second electronic device according to the position information comprised in the request for establishing the ODVLL.

8. The device according to claim 7, wherein the routers located between the first electronic device and the second electronic device are those routers with geographic positions between the geographic positions of the first electronic device and the second electronic device.

9. The device according to claim 6, wherein the path selection module determines the routers with workloads less than a predetermined value, and selects least adjacent routers with workload less than the predetermined value to form the optimal transmission path between the first electronic device and the second electronic device.

10. The device according to claim 9, wherein the workload of each router comprises a network utilization ratio of the router, and the path selection module determines the workload of the router is less than the predetermined value by determining the network utilization ratio is less than the predetermined value.

11. The device according to claim 6, wherein the transmission management device is a network server, and the routers connected to the transmission management device via the communication unit belong to different network operators.

12. A transmission management method, applied in a transmission management device comprising a storage unit, the method comprising:
receiving a request for establishing an on-demand virtual lease line (ODVLL) from a first electronic device when the first electronic device request to communicate with a second electronic device and send data to the second electronic device;
determining geographic positions of the first electronic device and the second electronic device, and obtaining geographic positions of a plurality of routers from the storage unit;
determining a data transmission direction according to the geographic positions of the first electronic device and the second electronic device;
determining a first group of routers adjacent to the first electronic device and located on the data transmission direction relative to the first electronic device, and determining a second group of routers adjacent to the first group of routers and located on the data transmission direction relative to the first group of routers, until determining all routers located between the first electronic device and the second electronic device;
analyzing positions and workloads of the routers located between the first electronic device and the second electronic device, and determining a optimal transmission path according to the positions and workloads of the routers located between the first electronic device and the second electronic device; and
controlling the first electronic device and the second electronic device to communicate with each other via the determined optimal transmission path.

13. The method according to claim 12, wherein the request for establishing the ODVLL comprises position information of both of the first electronic device and the second electronic device, and the position information of the first electronic device and the second electronic device respectively comprises a geographic position and an internet protocol (IP) address of the first electronic device and the second electronic device; the step of determining geographic positions of the first electronic device and the second electronic device comprises:
determining the geographic positions of the first electronic device and the second electronic device according to position information comprised in the request for establishing the ODVLL.

14. The method according to claim 12, wherein the step of analyzing positions and workloads of the routers located between the first electronic device and the second electronic device, and determining a optimal transmission path according to the positions and workloads of the routers located between the first electronic device and the second electronic device comprises:
analyzing positions and workloads of the routers located between the first electronic device and the second electronic device;
determining the routers with workloads less than a predetermined value; and
selecting least adjacent routers with workloads less than the predetermined value to form the optimal transmission path between the first electronic device and the second electronic device.

15. The method according to claim 14, wherein the workload of each router comprises a network utilization ratio of the router, the step of analyzing workloads of the routers located between the first electronic device and the second electronic device comprises:
determining the workload of the router is less than the predetermined value by determining the network utilization ratio is less than the predetermined value.
